(19) United States
(12) Patent Application Publication
(10) Pub. No.: US 2014/0186569 A1
(43) Pub. Date: Jul. 3, 2014

(54) Floor mat with a top cover

(71) Applicant: John R. Austin, Bradbury, CA (US)

(72) Inventor: John R. Austin, Bradbury, CA (US)

(21) Appl. No.: 13/730,763

(22) Filed: Dec. 28, 2012

(51) Int. Cl. B32B 3/06

(52) U.S. Cl. CPC B32B 3/06
USPC 428/58

(57) ABSTRACT

A floor mat for preventing slipping on a floor surface comprises a mat resting on a floor surface, a cover sheet placed on the top surface of the mat and a securing mechanism designed to secure the cover sheet to the mat. The mat includes the top surface, a bottom surface, a first pair of opposing edges and a second pair of opposing edges. The cover sheet also includes a first pair of opposing edges and a second pair of opposing edges. Each of the first pair of opposing edges of the mat and each of the second pair of opposing edges of the mat are arranged orthogonally to provide a flat shape to the mat. The securing mechanism is adaptable to securely hold the mat and the cover sheet together without relative movement between the mat and the cover sheet.

### BACKGROUND OF THE DISCLOSURE

1. Technical Field of the Disclosure

This embodiment relates in general to floor mats. More specifically, this embodiment relates to a floor mat having a removable top cover.

2. Description of the Related Art

Floor mats are usually used outside or just inside the entrance to a house or other building, to allow people to easily clean off the bottom of their footwear before entering a building. Floor mats provide absorbent and/or scrubbing surfaces to clean and dry the bottom of footwear to prevent slips and falls upon entering a building; and to prevent tracking in dirt or mud attached to the bottom of footwear. Various types of floor mats are available which use holders or clips to prevent slippage of the mats on the floor. Floor mats can also be used in vehicles to protect the carpeting of cars from dirt and wear and tear.

Conventional floor mats have considerable drawbacks. For example, an existing mat includes at least one layer of material having a top surface, a bottom surface, and side surfaces. Systems for removably securing the mat to carpeted surfaces and for preventing the mat from slipping on non-carpeted surfaces are also available. This existing mat does not employ any means for reducing the wear and tear of the mat.

Another existing floor mat includes a retainer with a series of male or female fasteners, and a plurality of openings corresponding to these fasteners. The retainer may be one sided or two sided and is used to attach the floor mat to the floor of an automobile. The plurality of openings is provided to align with the male fasteners to firmly attach the floor mat to the retainer. This method of fastening the retainers to the floor mat can be complex and time consuming.

Yet another existing floor mat embodiment is comprised of a floor mat formed from a series of first and second crisscrossed ribs; a clip having a rectangular-shape base; and four outwardly extending raised projections. The first and second crisscrossed ribs form rectangular shaped openings. The projections of the clip have a generally triangular-shaped end which snap-fits with the latching shoulder of certain second ribs and which aligns with certain openings of the floor mat. The clip includes a pair of holes which align with the openings of the floor mat when attached. When the mat is installed onto clip, clip is angled to one side and projections of the one side are inserted into respective aligned openings. However, installation of this floor mat is difficult due to its complexity. Further, this floor mat does not provide protection from wear and tear.

Hence, it can be seen, that there is a need for a floor mat that is removably secured to various types of floors to prevent it from slipping. This needed floor mat would include a cover sheet to provide resistance to wear and tear. This cover sheet would also allow the user to incorporate company logos or designs for advertising purposes. The cover sheet could be easily and cheaply replaced without the necessity of replacing the entire floor mat due to wear and tear. Such a floor mat would also include a securing mechanism to hold the floor mat and the cover sheet together. The present embodiment accomplishes these objectives.

### SUMMARY OF THE DISCLOSURE

To minimize the limitations found in the prior art, and to minimize other limitations that will be apparent upon the reading of the specifications, the present invention provides a floor mat for preventing slipping on a floor surface. The floor mat comprises a mat resting on a floor surface, a cover sheet placed on the top surface of the mat and a securing mechanism designed to secure the cover sheet to the mat. The mat includes the top surface, a bottom surface, a first pair of opposing edges and a second pair of opposing edges. The cover sheet also includes a first pair of opposing edges and a second pair of opposing edges. The securing mechanism is adaptable to securely hold the mat and the cover sheet together without relative movement between the mat and the cover sheet. The securing mechanism is used to secure one of the first pair of opposing edges of the mat to one of the first pair of opposing edges of the cover sheet. The securing mechanism is also used to secure one of the second pair of opposing edges of the mat to one of the second pair of opposing edges of the cover sheet. Each of the first pair of opposing edges of the mat and each of the second pair of opposing edges of the mat are arranged orthogonally to provide a flat shape to the mat.

One objective of the invention is to provide a floor mat with a cover sheet and a securing mechanism for preventing slipping on a floor surface.

Another objective of the invention is to provide a securing mechanism designed to secure the cover sheet to the mat.

A third objective of the invention is to provide a floor mat with a cover sheet having resistance to wear and tear, absorbability, disposability and changeability.

These and other advantages and features of the present invention are described with specificity so as to make the present invention understandable to one of ordinary skill in the art.

### BRIEF DESCRIPTION OF THE DRAWINGS

Elements in the figures have not necessarily been drawn to scale in order to enhance their clarity and improve understanding of these various elements and embodiments of the invention. Furthermore, elements that are known to be common and well understood to those in the industry are not depicted in order to provide a clear view of the various embodiments of the invention, thus the drawings are generalized in form in the interest of clarity and conciseness.

FIG. 1 shows a top view of a floor mat for preventing slipping on a floor surface in accordance with a preferred embodiment of the present invention;

FIG. 2 shows a perspective view of the floor mat shown in FIG. 1;

FIG. 3 shows an exploded view of the securing mechanism of the floor mat in accordance with the preferred embodiment of the present invention.

FIGS. 4A-4C illustrate an exemplary embodiment of the securing mechanism of the floor mat in accordance with the preferred embodiment of the present invention; and

FIG. 5 shows a perspective view of another embodiment of the floor mat shown in FIG. 1.

### DETAILED DESCRIPTION OF THE DRAWINGS

In the following discussion that addresses a number of embodiments and applications of the present invention, reference is made to the accompanying drawings that form a part hereof, and in which is shown by way of illustration specific embodiments in which the invention may be practiced. It is to be understood that other embodiments may be utilized and changes may be made without departing from the scope of the present invention.

Various inventive features are described below that can each be used independently of one another or in combination with other features. However, any single inventive feature may not address any of the problems discussed above or only address one of the problems discussed above. Further, one or more of the problems discussed above may not be fully addressed by any of the features described below.

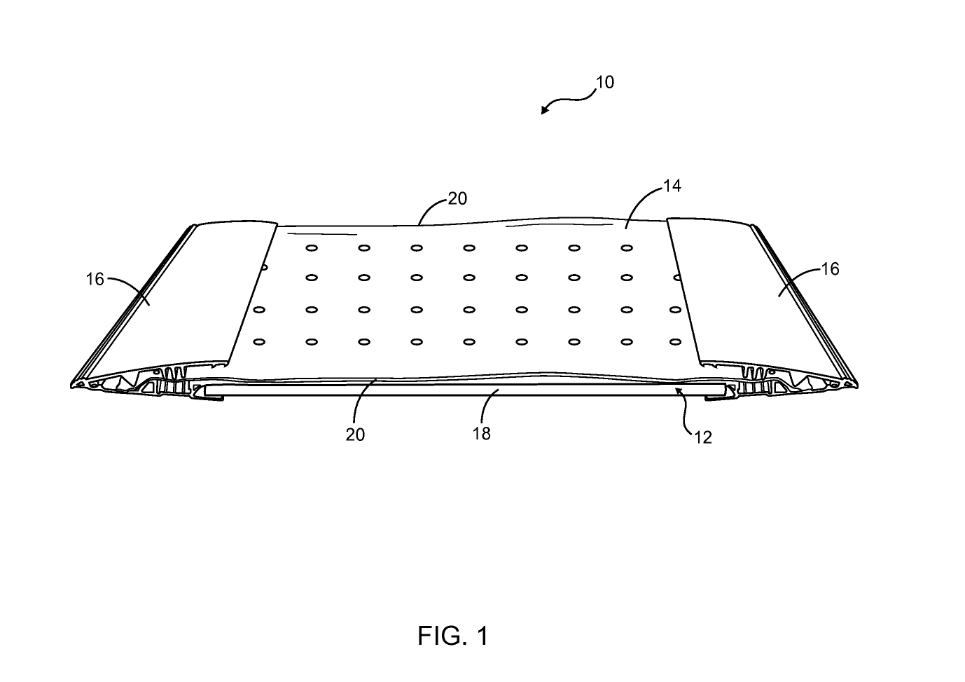

FIG. 1 shows a perspective view of a floor mat 10 for preventing slipping on a floor surface in accordance with a preferred embodiment of the present invention. The floor mat 10 comprises a mat 12 resting on a floor surface, a cover sheet 14 placed on the top surface of the mat (not shown) and a securing mechanism 16 designed to secure the cover sheet 14 to the mat 10. The mat includes the top surface (not shown), a bottom surface (not shown), a first pair of opposing edges 18 and a second pair of opposing edges (not shown). The cover sheet 14 also includes a first pair of opposing edges 20 and a second pair of opposing edges 22. The securing mechanism 16 is adaptable to securely hold the mat 12 and the cover sheet 14 together without relative movement between the mat 12 and the cover sheet 14.

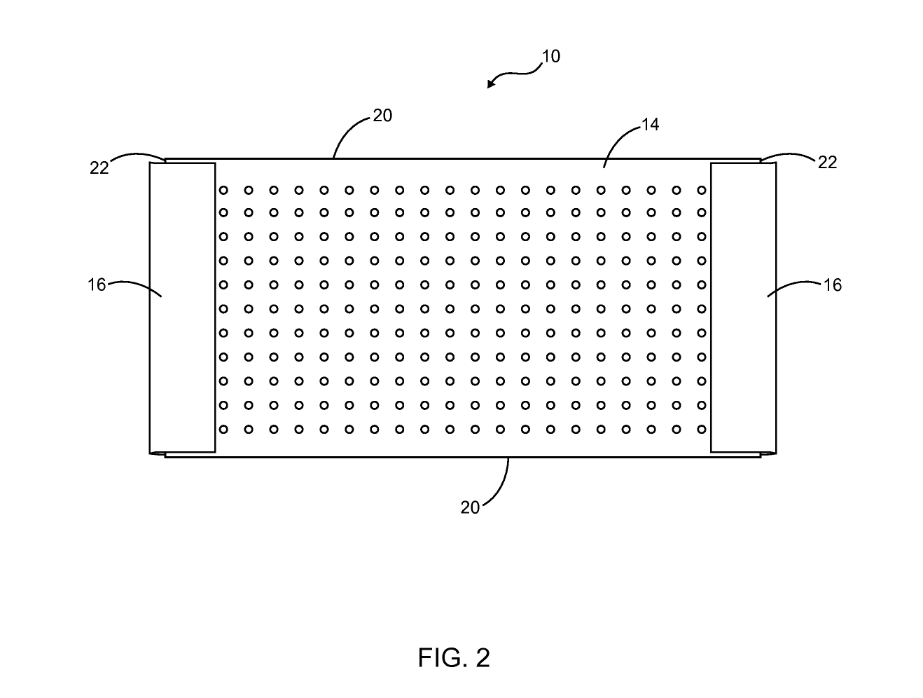

FIG. 2 shows a top view of a floor mat 10 shown in FIG. 1. The securing mechanism 16 is used to secure one of the first pair of opposing edges of the mat 18 to one of the first pair of opposing edges of the cover sheet 20. The securing mechanism 16 is used to secure one of the second pair of opposing edges of the mat (not shown) to one of the second pair of opposing edges of the cover sheet 22. Each of the first pair of opposing edges of the mat 18 and each of the second pair of opposing edges of the mat (not shown) are arranged orthogonally to provide a flat shape to the mat 12. The mat 12 may be made of a material selected from a group consisting of: rubber, plastic and foam. The cover sheet 14 may be made of fabric.

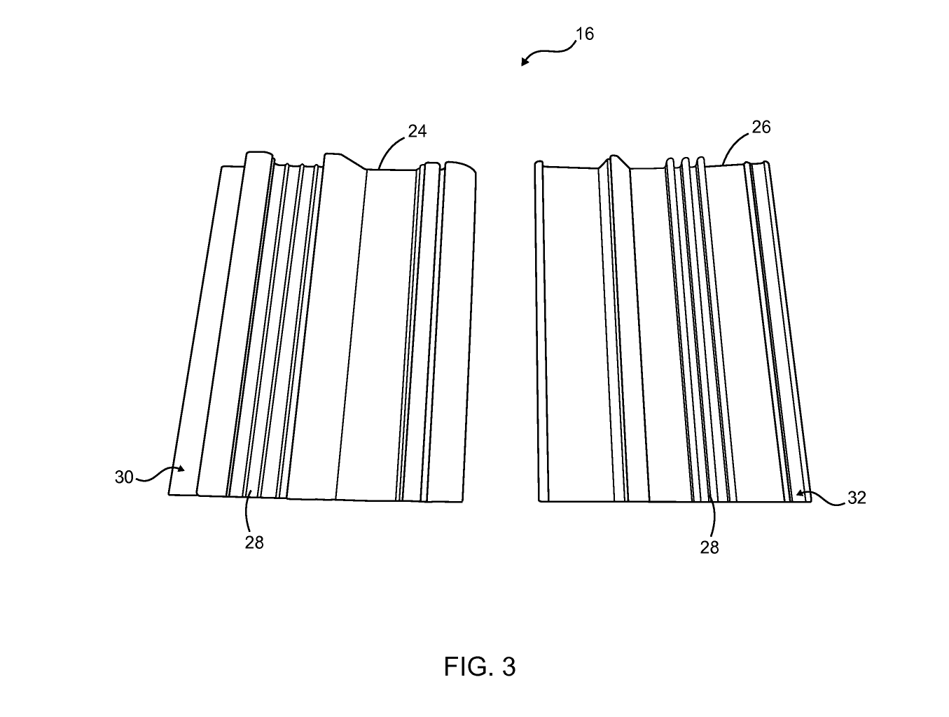

FIG. 3 shows an exploded view of the securing mechanism 16 of the floor mat in accordance with the preferred embodiment of the present invention. The securing mechanism 16 may be selected from a group consisting of: clamps, clips, rails, braces, fasteners, hinges, channels and spring metals. The securing mechanism 16 may be made of a material selected from a group consisting of: metal and plastic. In this preferred embodiment of the floor mat 10, the securing mechanism is a clamp 16. The clamp 16 includes a top part 24, a bottom part 26 and a hinge portion (not shown). A plurality of matching grooves 28 is included on an inner surface of the top part 30 and an inner surface of the bottom part 32. The cover sheet 14 is rested on the top surface of the mat with one of its edges inserted into a center portion of the clamp (not shown) so that the plurality of grooves 28 can secure the edges of the cover sheet 14 and the mat 12 together. The top surface of the top part of the clamp (not shown) is curved with lower end outward to prevent tripping. The hinge portion (not shown) is designed to be locked when the top part 24 of the clamp is pressed downward.

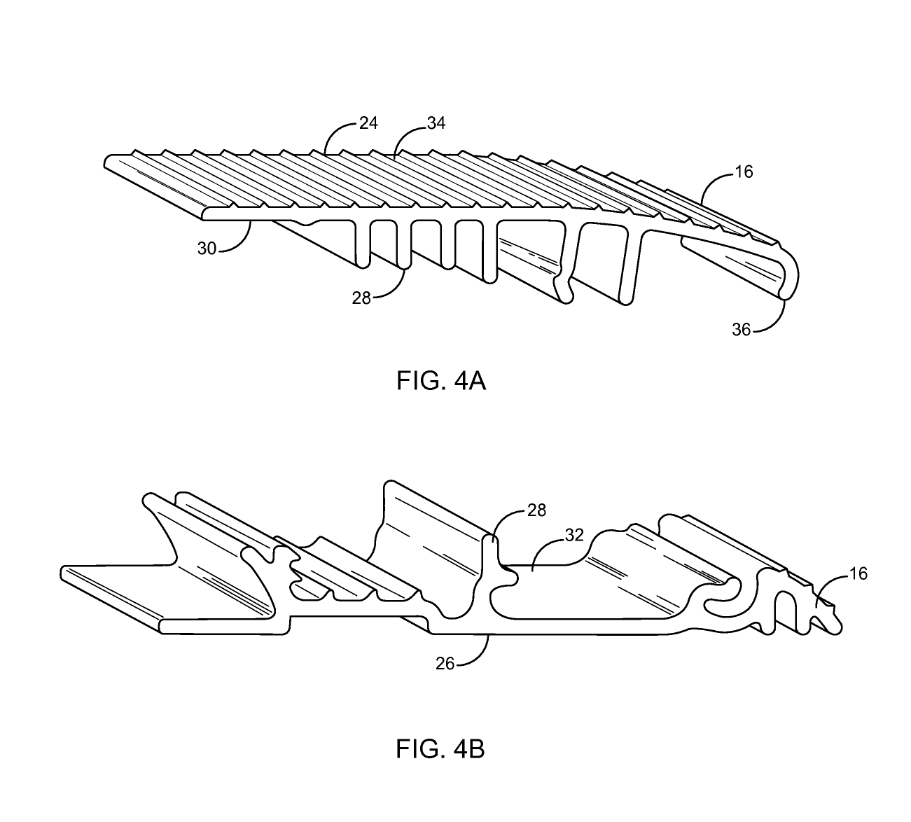

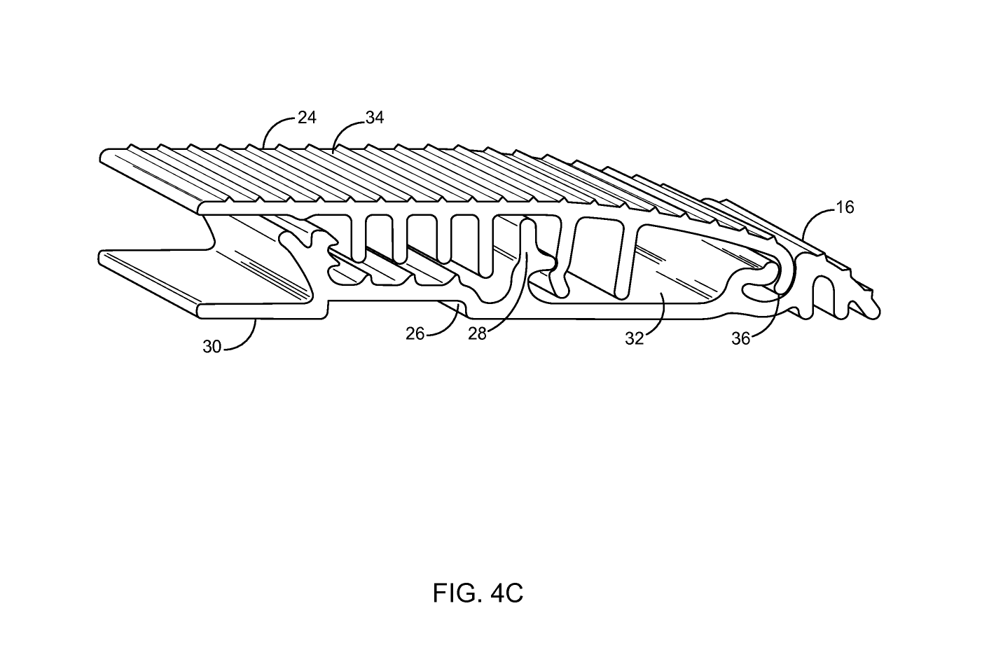

FIGS. 4A-4C illustrate an exemplary embodiment of the securing mechanism of the floor mat in accordance with the preferred embodiment of the present invention. In the present invention, the preferred securing mechanism is the clamp 16. The clamp 16 is designed with the top part 24, the bottom part 26 and the hinge portion (not shown). The inner surface of the top part 30 and the inner surface of the bottom part 32 include the plurality of matching grooves 28. The top surface of the top part of the clamp 34 is curved with lower end 36 outward to prevent tripping. The clamp 16 may be made of a material selected from a group consisting of: metal and plastic. The clamp 16 can be used to secure the mat 12 and the cover sheet 14 together without relative movement between the mat 12 and the cover sheet 14.

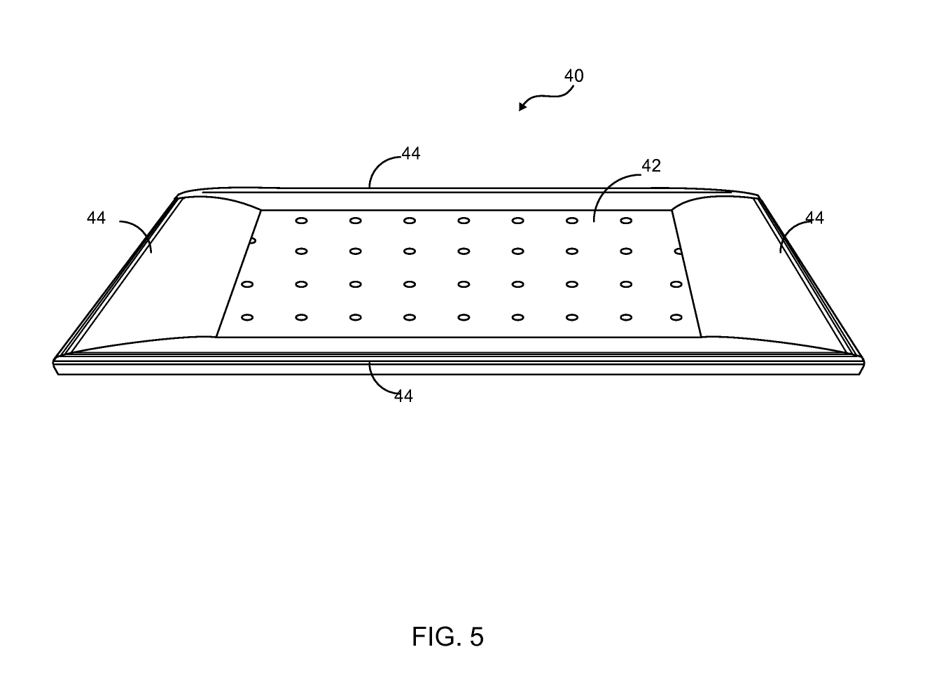

FIG. 5 shows a perspective view of another embodiment of the floor mat 40 shown in FIG. 1. The floor mat 40 comprises a mat (not shown) resting on a floor surface, a cover sheet 42 placed on the top surface of the mat (not shown) and a securing mechanism 44 designed to secure the cover sheet 42 to the mat (not shown). The securing mechanism 44 is adaptable to securely hold the mat (not shown) and the cover sheet 42 together without relative movement between the mat (not shown) and the cover sheet 42. In this embodiment, the securing mechanism 44 is secured in such a way that the securing mechanism 44 surrounds all the edges of the floor mat 40, making the edges of the mat (not shown) and the cover sheet 42 all secured together.

The floor mat 10 of the present invention is designed to be used to prevent slipping on floor surfaces. The cover sheet 14 may have resistance to wear and tear, absorbability, disposability and changeability. The cover sheet 14 can be easily and cheaply replaced without the necessity of replacing the entire floor mat due to wear and tear. The cover sheet 14 may also be used to display company logos and/or creative designs for advertising purposes. The floor mat 10 may vary in color, texture and custom graphics. The floor mat 10 is also modular, user-friendly and easy to use.

The foregoing description of the preferred embodiment of the present invention has been presented for the purpose of illustration and description. It is not intended to be exhaustive or to limit the invention to the precise form disclosed. Many modifications and variations are possible in light of the above teachings. It is intended that the scope of the present invention not be limited by this detailed description, but by the claims and the equivalents to the claims appended hereto.

What is claimed is:

1. A floor mat for preventing slipping on a floor surface, the floor mat comprising:
a mat resting on a floor surface, the mat having a top surface, a bottom surface, a first pair of opposing edges and a second pair of opposing edges;
a cover sheet placed on the top surface of the mat, the cover sheet having a first pair of opposing edges and a second pair of opposing edges; and
a securing mechanism designed to secure the cover sheet to the mat;
whereby the securing mechanism is adaptable to securely hold the mat and cover sheet together without relative movement between the mat and the cover sheet.

2. The floor mat of claim 1 wherein the securing mechanism is used to secure one of the first pair of opposing edges of the mat to one of the first pair of opposing edges of the cover sheet.

3. The floor mat of claim 1 wherein the securing mechanism is used to secure one of the second pair of opposing edges of the mat to one of the second pair of opposing edges of the cover sheet.

4. The floor mat of claim 1 wherein each of the first pair of opposing edges of the mat and each of the second pair of opposing edges of the mat are arranged orthogonally to provide a flat shape to the mat.

5. The floor mat of claim 1 wherein the securing mechanism may be selected from a group consisting of: clamps, clips, rails, braces, fasteners, hinges, channels and spring metals.

6. The floor mat of claim 1 wherein the securing mechanism may be made of a material selected from a group consisting of: metal and plastic.

7. The floor mat of claim 1 wherein the mat may be made of a material selected from a group consisting of: rubber, plastic and foam.

8. The floor mat of claim 1 wherein the cover sheet may be made of fabric.

9. The floor mat of claim 1 wherein the cover sheet may have resistance to wear and tear, absorbability, disposability and changeability.

10. The floor mat of claim 1 wherein the cover sheet may be used to display company logos and/or creative designs.

11. The floor mat of claim 1 wherein the floor mat may vary in color, texture and custom graphics.
